(19) United States
(12) Patent Application Publication
(10) Pub. No.: US 2008/0049015 A1
(43) Pub. Date: Feb. 28, 2008

(54) System for development of 3D content used in embedded devices

(76) Inventors: Baback Elmieh, Carlsbad, CA (US); David L. Durnil, San Diego, CA (US)

Correspondence Address: QUALCOMM INCORPORATED, 5775 MOREHOUSE DR., SAN DIEGO, CA, 92121, US

(21) Appl. No.: 11/509,436

(22) Filed: Aug. 23, 2006

(51) Int. Cl. G06T 17/00; G06F 3/00

(52) U.S. Cl. 345/420; 715/700

(57) ABSTRACT

Apparatus are provided which include exported assets and an exporter. The exported assets define a 3D user interface, and include 3D model assets defining 3D models and animation assets defining animations of the 3D models. The exported assets are exported from a 3D image defining system. The exporter exports the exported assets from the 3D image defining system, to cause the exported assets to be in a format usable in a graphics engine in an embedded device.

### COPYRIGHT NOTICE

This patent document contains information subject to copyright protection. The copyright owner has no objection to the facsimile reproduction by anyone of the patent document or the patent, as it appears in the U.S. Patent and Trademark Office files or records, but otherwise reserves all copyright rights whatsoever.

### FIELD OF THE DISCLOSURE

Aspects of the disclosure relate to tools and features to facilitate the development and implementation of 3D content used in embedded devices. The embedded devices may be mobile devices that capture, receive, and/or transmit voice, data, text, and/or images. Other aspects of the disclosure relate to tools and features to facilitate the development and implementation of graphical user interfaces for such devices.

### BACKGROUND OF THE DISCLOSURE

Various systems exist which facilitate the development and implementation of 3D content used in embedded devices. Such embedded devices generally include displays to display the 3D content. In this regard, Qualcomm Corporation sells many software products under the trade name BREW, which include, for example, SDKs, which can be run on a given computer platform to develop programs for providing 3D content in embedded devices, such as mobile phones.

### SUMMARY OF THE DISCLOSURE

In accordance with one embodiment, apparatus are provided, which include exported assets and an exporter. The exported assets define a 3D user interface, and include 3D model assets defining 3D models and animation assets defining animations of the 3D models. The exported assets are exported from a 3D image defining system. The exporter exports the exported assets from the 3D image defining system, to cause the exported assets to be in a format usable in a graphics engine in an embedded device.

### BRIEF DESCRIPTION OF THE DRAWINGS

Non-limiting example embodiments of the disclosure are further described in the detailed description, which follows, by reference to the noted drawings, in which like reference numerals represent similar parts throughout the several views of the drawings, and wherein:

FIG. 1 is a block diagram of a 3D content development system;

FIG. 2 is a block diagram of software architecture for an embedded device;

FIG. 3 is a schematic diagram of a data structure of a 3D model file; and

FIG. 4 is a schematic diagram of a data structure of a UI layout file.

### DETAILED DESCRIPTION

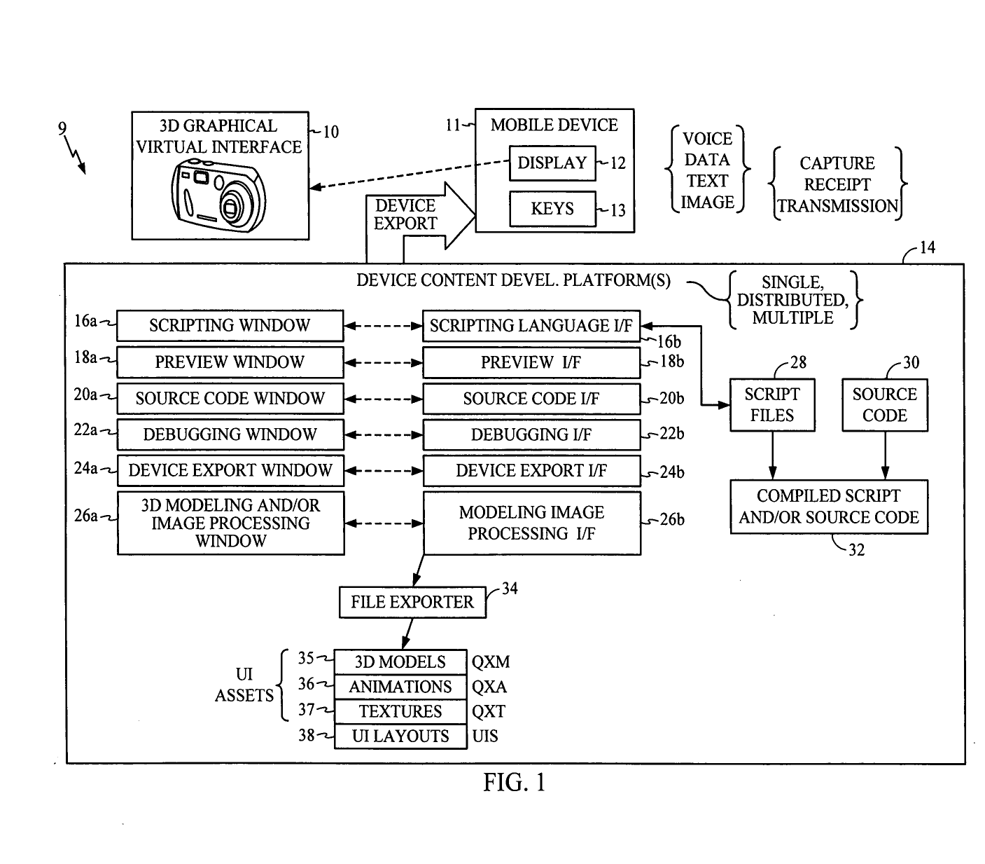

Referring now to the drawings in greater detail, FIG. 1 illustrates a 3D content development system 9. The illustrated system 9 includes a device content development platform or platforms 14, a mobile device 11, and a 3D graphical virtual interface 10 which is caused to be displayed on a display 12 of mobile device 11.

Mobile device 11 may, for example, be a mobile phone. The illustrated mobile device 11 is an embedded device, which captures, receives, and/or transmits voice, data, text, and/or images. The illustrated mobile device 11 further includes keys 13, to allow the control of mobile device 11 and the input of information into mobile device 11.

The illustrated device content development platform(s) may be a single, distributed, or multiple platforms. The illustrated platform(s) includes a number of software interfaces which interact with and provide corresponding windows or screens on a computer platform. These include a scripting window 16a and a corresponding scripting language interface 16b. A preview window 18a is provided which corresponds to a preview interface 18b. A source code window 20a is provided which corresponds to a source code interface 20b. A debugging window 22a is provided which corresponds to a debugging interface 22b. A device export window 24a is provided which corresponds to a device export interface 24b. A 3D modeling and/or image processing window 26a is provided which corresponds to a modeling/image processing interface 26b.

The illustrated 3D graphical virtual interface 10 graphically portrays and simulates a physical device with its interface components, and therefore, serves as a 3 dimensional (3D) user interface, with icons embedded therein.

Scripting language interface 16b is coupled to, and generates, one or more script files 28, which cater to the building of 3D user interfaces. Those script files 28 provide information for 3D icon and scene definition as well as for programming the animation of the defined 3D icons and scenes. The 3D icons and scenes, as animated, may be tied to or associated with mobile device 11, and tools thereof, to control or input and/or to display or output various mobile device operations, settings, events, and/or statuses.

Each of the interfaces 16b, 18b, 20b, 22b, 24b, and 26b is operable, through the use of its corresponding window, to receive controls and information via a computer screen and to display information to the user.

Preview interface 18b causes a viewer to load textures and animations. All files associated with a particular 3D model may be played, along with material animations and hierarchical animations of that 3D model.

Source code interface 20b, in connection with the source code window 20a, allows for the creation of a program using source code, typically using commands provided in code provided for original equipment manufacturers (OEMs).

Debugging interface 22b, interacting with debugging window 22a, facilitates the simulation of script files 28 for purposes of checking and debugging the script file. Device export interface 24b, together with device export window 24a, may allow a user to cause compiled script and/or source code to be exported to a mobile device 11.

Modeling/imaging processing interface 26b includes software for allowing an artist to perform 3D modeling and/or imaging processing through the use of 3D modeling and/or imaging processing window 26a, to create 3D assets for conversion into user interface assets and for the definition of user interface layouts to form and ultimately define a 3D user interface.

Scripting language interface 16b produces script files 28, while source code interface 20b produces source code 30. Either or each of these types of code may be compiled to produce compiled script and/or source code 32.

A file exporter 34 is provided to export files, i.e., convert such files, from modeling/image processing interface 26b into certain types of files that can be usable by the compiled script and/or source code 32 to create a particular type of 3D user interface which can be exported to mobile device 11. The “exporting” performed by file exporter 34 is distinct from the exporting performed by a device export interface 24b, in that the file exporter 34 simply converts information into files that are compatible with the compiled script and/or source code 32 (and also usable by a graphics engine that operates in accordance with the compiled code), while the device export interface 24b facilitates the physical exporting of such compiled script and/or source code, and associated user interface assets and user interface layout files, into mobile device 11.

In the illustrated embodiment, file exporter 34 exports information from modeling/image processing interface 26b into a set of files defining user interface assets 35, 36, and 37, and a set of files defining user interface layouts 38. Specifically the user interface assets include 3D models 35, animations 36, and textures 37. Modeling/image processing interface 26b and the corresponding 3D modeling and/or image processing window 26a may be implemented with standard software that is commercially available. For example, such standard software may include, for example, Maya.

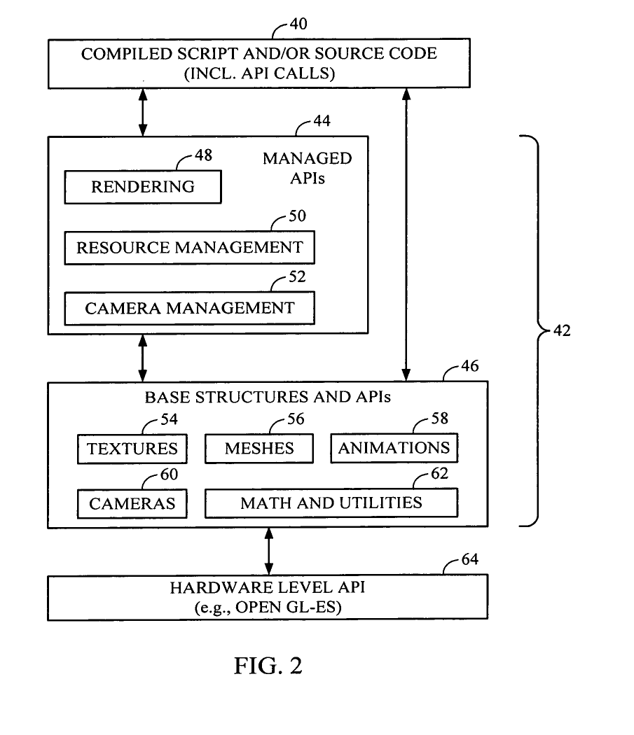

FIG. 2 provides an architectural diagram of the software in one example embodiment, once exported into a mobile device 11. The architecture includes compiled script and/or source code 40 (which includes API calls), managed APIs 44, base structures and APIs 46, and a hardware level API 64. The compiled script and/or source code communicates directly with, i.e., performs API calls to API functions within, each of managed APIs 44 and base structures and APIs 46. The managed APIs 44 include a rendering API 48, a resource management API 50, and a camera management API 52. Rendering API 48 takes care of render states. Resource management API 50 takes care of memory management and other bookkeeping tasks.

The base structures and APIs 46 include textures 54, meshes 56, animations 58, cameras 60, and math and utilities 62. These structures and APIs provide full access to all geometry, animation streams, and other underlying engine data types. In addition, fixed point math and container structures may be provided that can be used independently of the rest of the engine. Applications may be implemented, embodied within compiled script and/or source code 40, so as to interface through managed APIs 44 for some or all functions. They may implement their own resource management and memory instantiation techniques, and, accordingly, interface directly with base structures and APIs 46. Moreover, completely bypassing managed APIs 44 is possible in the event an OEM developer wishes to write source code that takes advantage of exporters and mesh optimization tools or otherwise retain control over how higher-level functionality is implemented.

Managed APIs 44 together with base structures and APIs 46 comprise an optimization engine layer 42. The hardware level API 64 may include, for example, Open GL-ES, Direct 3D mobile, and SKT GIGA software. Files 35, 36, 37, and 38 are exported assets that define 3D models and animations of the 3D models. The exported assets are exported from modeling/image processing interface 26b, which, in the illustrated embodiment, includes a standard 3D modeling or imaging processing system. File exporter 34 exports the 3D model and animation assets from a 3D image defining system (which includes modeling/image processing interface 26b), to cause the assets to be in a format usable in a graphics engine, i.e., by one or both of managed APIs 44 and base structures and APIs 46. The exported assets may define 3D models including 3D icons and scenes of icons. In addition to models and animations, the assets may further include textures associated with shapes in the 3D models. The graphics engine may be an Open GL-ES-compatible, Direct 3D mobile-compatible, and SKT GIGA-compatible graphics engine. The embedded device may be a mobile device. Specifically, the embedded device may include a hand-held mobile communications device platform, wherein the device platform includes one or more integrated circuits. The exported assets may be stored in a memory on an integrated circuit.

The illustrated system includes a tool chain which includes file exporter 34. The tool chain may further include scripting language interface 16b to receive, via computer screen input through scripting window 16a, script statements defining a 3D user interface, and to generate a set of script files 28 representing the script statements defining the 3D user interface. The script files 28 may be stored; the script files may be XML script.

The tool chain may further include icon association mechanisms to associate a given 3D object in a scene with a mobile phone interface tool to cause, by manipulation of the given 3D object, at least one of an input and an output of a signal or information regarding the mobile phone.

Such input may involve a controlling function, a switch state change, and/or textual input. Such output may involve information display, or a state or status indication. The control, input and output, may all be regarding operations, settings, events, states, and statuses of a mobile phone.

The file exporter 34 includes a file generator to generate 3D model files 35, animation files 36, texture files 37, and user interface layout files 38.

Each of the subsystems depicted in the platform(s) 14 may include software that is running on a common platform or on different computers. For example, scripting language interface 16b and corresponding scripting window 16a may be running on one computer, while, for example, modeling/image processing interface 26b and corresponding 3D modeling and/or image processing window 26a are running on a different computer.

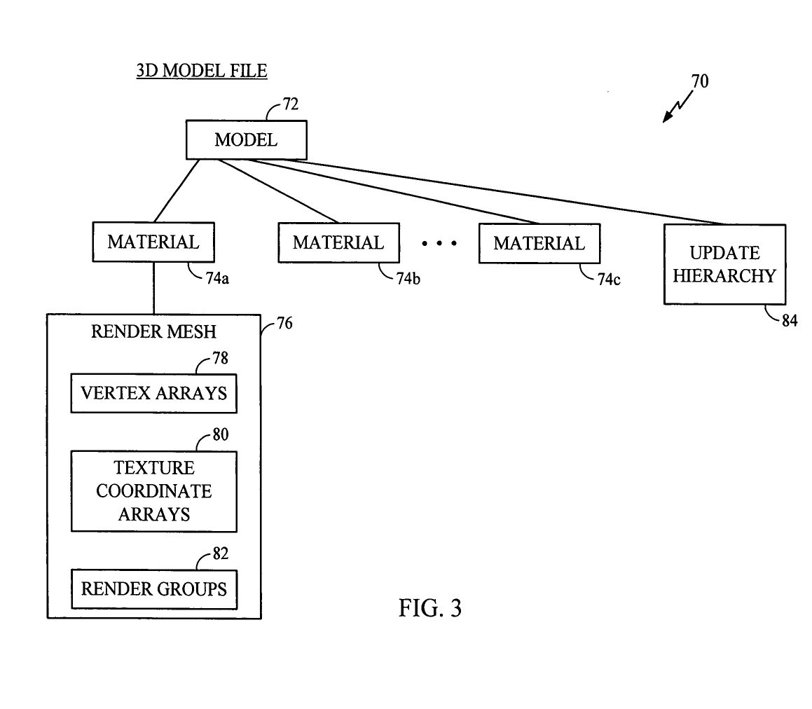

FIG. 3 schematically shows one embodiment of the data structure of a 3D model file 70. In the illustrated embodiment, a 3D model file includes data saved as a file with a .qxm extension. A given 3D model file 70 includes an identifier 72 identifying the model 72, and sets of material parameters 74a, 74b, . . . 74c, defining the manner in which geometry for that model can be drawn. A particular material 74a, for example, may have a particular texture and mapping color of the mesh, a particular transparency value, and a particular incandescence value. Material information 74a includes these rendering parameters. A render mesh 76 is provided that corresponds to a given set of material parameters 74a. In the illustrated structure, render mesh 76 includes vertex arrays 78, texture coordinate arrays 80, and render groups 82. The render groups include groups of render primitives (triangle-strips, triangle-lists, and so on.). One or more update hierarchies 84 may be provided, which are used for animations and for transforming render groups from local space to world space.

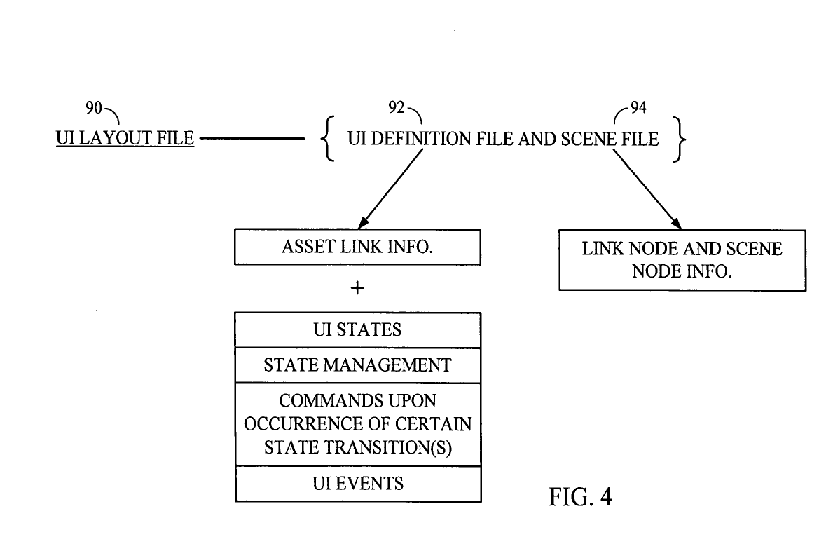

FIG. 4 schematically depicts a data structure of a user interface layout file 90. In the specific embodiment illustrated herein, a UI layout file includes data saved as a file with a .uis extension. A UI layout file 90 includes a UI definition file 92 and a scene file 94. UI definition file 92 includes asset link information and other information including UI states; state management; commands upon occurrence of certain state transitions; and UI events. Scene file 94 includes link node information and scene node information.

Scene nodes are all those nodes that are not linked to a 3D model. Link nodes have 3D models associated therewith. The models associated with link nodes are exported to their own files, and their link node association is specified in the UI definition file 92. The scripting language is used to provide a set of tags that can be used in connection with externally created 3D assets, otherwise referred to as user interface assets, produced by another set of software, modeling/image processing interface 26b as shown in FIG. 1. Such external software may, for example, include Alias' “Maya” or images produced by, for example, Photoshop. These files produced by this external software are exported by file exporter 34, and thereby converted into formats compatible with the 3D user interface development code 32 as compiled from script files 28 and/or source code 30.

In embodiments herein, a scene is a type of 3D “world”. It is the place where 3D elements actually live. If a person is animated, then the scene in which that person is located can be a room. A scene can be large or small. For example, a set of 3D icons may each be in their own little world. For example, a scene for a particular icon can be a box surrounding that icon. Alternatively, all of the 3D icons could coexist in one scene comprising a bigger box that takes up the whole computer screen. A user interface can support several scenes, or alternatively, just one big scene.

A scene includes nodes. A node is a point in a scene at which objects are attached. A person in a room may be “attached” to a point represented by an X on the floor. A light may be attached to a point marked by where the electric cord comes out of the ceiling. There may be many nodes in a scene, and nodes themselves can be animated.

A model is a term that describes the behavior of each of the objects in a scene. Each object may have a model, or a model can comprise several objects. In one example, a puppy may be depicted which chases and fetches a ball when instructed. This puppy is defined as a model, which can be represented by an invisible wire-frame describing its shape and behavior, which in this case also includes the ball that the puppy chases and the checker-board base the puppy sits on. All three components are part of the same model. There can be many models in a scene, but each model is essentially independent of the other.

Mesh geometry can be drawn in various ways; it can be painted with a solid color, smoothly shaded between the colors at its vertices, or drawn with a texture map. Textures are a name for a specially-formatted image which is used to “drape” over the geometry represented by a model in order to give it a detailed surface. Textures are defined in texture files, in the illustrated embodiment, which may, for example, include the extension .qxt. Those textures are associated with the geometry they modify, for example, by the manner in which the name of the file is specified.

Each scene has at least one camera. The camera is the view onto the scene, and much like an animated object, is defined by a node in the scene specified by the author. A camera, in the embodiment, is activated before one can see through the camera. Switching on another camera may result in the automatic turning off of an already-active camera. A default camera (looking at the center of the world) may be provided for every scene, which is activated if no other camera is turned on.

A scene may have one or more lights. In addition, or alternatively, a scene may include default ambient “all-over” lighting. It is possible to bake lighting into vertex color and texture of a model to simulate static lighting in this ambient mode. Life-like dynamic lighting may be achieved by adding a light to a scene. A light is attached to a node, but in addition, it is associated with another node. That is, that association of the light to the other node defines the direction in which the light shines. Accordingly, a light can be pointed like a “torch”. In addition, one may define lights, and include parameters to specify the color of the light that is shined into the scene.

One or more animation files, files with the extension .qxa in the illustrated embodiment, may be provided, that describe how an object is animated. When an animation file is called upon, it is applied to a specific node within the scene. Animation files are a bit like a strip of film (or a timeline in Flash), and contain a set of frames. These frames do not have to represent a continuous sequence, and can contain several completely different animations in the same frame “stack”, which is why, in the illustrated embodiment, when they are called upon, both a start frame and an end frame are specified.

When an animation is activated, it is applied to a specific named node that it is meant to animate. By way of example, one animation file may be provided for animating a puppy, while a separate animation file is provided for animating the camera and light. The instructions specified in an animation file are applied to the object attached to that node. For example, a puppy may spin on a spot, fly around the scene, or jump up and down.

A 4-way navigation key that typically is provided in a mobile device key board can be used to animate a puppy in various ways. For example, in this example, one may press the right nav key and the ball rolls off to the right, shortly followed by the chasing puppy who retrieves it.

The 3D Scene.

q3dscene may be used as a tag that defines a 3D scene (or world). It takes a resource path which points to an imported filename .uis file (uis=UI Scene). If resources are exported from the puppy source using, for example, a plug-in (file exporter 34, as shown in FIG. 1), then there will be two .uis files—one called link_puppy.uis and the other called scene_puppy.uis. In this example, the puppy is one object, and everything else (the world, camera and lights) is another. It will be up to the author to make clear which is the scene that controls everything—in this case it is scene_puppy.uis.

A Resource Tree folder may be provided, e.g., holding a resource called PuppyScene_uis which contains the external file scene_puppy.uis—note that the names do not have to correspond.

The 3D Model.

A model is a mesh (or wire-frame) describing one of more visible objects. In this example, the puppy, the base it sits on and the ball are all part of the same model—this is because they are all dependent upon each other in some way. It would also be quite acceptable to have several models in the same scene—all attached to different nodes. However, in this scenario, each model would be independent of the other.

The attributes that the q3dmodel tag take are a resource path (in this case PuppyModel_qxm, which imports the external file link_puppy.qxm) as well as anchor node—this is the point (node) in the scene that this object (the puppy) attaches to. The model may be provided with one or more textures, without which it will appear in a uniform or per-vertex color. This command loads a 3D model asset (see FIG. 1) into memory using resource manager 50 (see FIG. 2).

Textures.

Textures may behave slightly differently than other imported resources. Models within a scene use textures and apply them so that they can be seen; however, there is no need to provide an attribute or tag to define a texture, as it is something that only the 3D content knows about. When a texture is accessed in this fashion, in the illustrated example embodiment, it is loaded into memory by resource manager 50 (FIG. 2).

The Camera.

In order to be able to look at the scene, at least one camera is provided. A camera may be defined with the q3dcamera tag and, once again, is something that the author of the content specifies. In the puppy example, a camera is attached to a node called Puppycam, and the camera tag has an attribute cameranode=“Puppycam”. There's also a startactive=“_true” to make sure that the camera is turned on as soon as this scene loads.

It is possible to define more than one camera in a scene, but in the embodiment illustrated herein, to simplify the program, only one can be active at any one time. Turning on a different camera automatically switches off the current camera.

The Lighting.

The optional tag q3dlight allows one to illuminate the scene by shining a light from one node to another. It is optional because, without it, the scene will assume its own default ambient lighting. A list of lights available in a scene should be provided by the 3D author.

In the example, three q3dlight tags are defined: they have the IDs white, red and green, are all attached (anchored) to the scene node x_light, and all point to the node link_puppy. Remember that the puppy model is attached to the node link_puppy, so in effect the light is shining on the puppy. Only the first light, white, is set to be active on startup, and so when this scene first loads, there will be light shining on the puppy. Like the camera, there is only one light allowed at a time (per node)—the content will later use events to switch each of these lights on in turn (and in doing so give the effect of changing the light's color).

At this point, a world has been defined populated with a puppy and ball, with a light shone on it, and provided with a camera so it can be seen. The real power of 3D animation comes with what can be done with this object (or objects) once defined, and this is exercised with the q3danim tag. The tag itself takes several attributes: sframe and eframe (start and end frame) provide a way of selecting particular parts of a given animation sequence. It also takes a resource, which points to an animation file 36; once loaded, it may be managed in memory by resource manager 50.

In the puppy example, the 3D resource tree folder includes two qxa (animation) files defined—PuppyModel_qxa and PuppyScene_qxa. The former describes animation specific to the puppy, and the latter contains animations for the light and the camera—it is very much an authoring decision how these animations are broken down. An attribute may be provided specifying the node to which the animation is applied, but this is not a random choice: each sequence of animations is specific to a particular object, so it would be no use, for example, to use an animation sequence meant for the camera and apply it to the puppy. The author of the 3D content should therefore make it clear which animation refers to which object. The final attribute provides control over whether or not the animation is looped.

Animating the Puppy.

In the fragment trigml/main, a few variables may be pre-defined. These are:

<setdata when=“_entry” res=“/var/camFrame” value=“0” />
<setdata when=“_entry” res=“/var/lightFrame” value=“0” />
<setdata when=“_entry” res=“/var/object” value=“puppy” />
<setdata when=“_entry” res=“/var/cameraMode” value=“smooth” />
<setdata when=“_entry” res=“/var/lightColor” value=“white” />

The first group of q3danim tags uses the state of one of these, /var/object, to test whether the device is in “puppy” mode. The reason for this is that the same 4-way navigation key will be used to drive several different animations (for the puppy, the camera and the light). So this first q3danim listener determines when there has been a _keyleft key press while the device is in puppy mode, and when this occurs, it applies the animation contained in the resource 3D/PuppyModel_qxa to the node link_puppy. It will use frames 250 through 350, and loop once. It will then listen for the remaining three possible keypresses (while ensuring that the device is still in “puppy” mode), and apply the relevant sequence of frames to the puppy in order to animate it.

Puppy Action Sequences

| Sequence Name | File Name | Node Name | Start Frame | End Frame | Frame Number | Loop/Hold | Description |
|---|---|---|---|---|---|---|---|
| Enter | link_Puppy | | 10 | 15 | 5 | Play | Go to Sit position |
| | link_Puppy | | 15 | 45 | 30 | Loop | Sit Idle Anim |
| Up | link_Puppy | | 50 | 65 | 15 | Play | Go to Up position |
| | link_Puppy | | 65 | 80 | 15 | Loop | Up Idle |
| | link_Puppy | | 80 | 95 | 15 | Play | Back to Sit position |
| | link_Puppy | | 15 | 45 | 30 | Loop | Sit Idle Anim |
| Down | link_Puppy | | 100 | 120 | 20 | Play | Go to Down position |
| | link_Puppy | | 120 | 135 | 15 | Loop | Down Idle |
| | link_Puppy | | 135 | 150 | 15 | Play | Back to Sit position |
| | link_Puppy | | 15 | 45 | 30 | Loop | Sit Idle Anim |
| Right | link_Puppy | | 150 | 200 | 50 | Play | Jump to right following the ball |
| | link_Puppy | | 200 | 250 | 50 | Play | Roll Left Back to Idle position |
| | link_Puppy | | 15 | 45 | 30 | Loop | Sit Idle Anim |
| Left | link_Puppy | | 250 | 300 | 50 | Play | Jump to Left following the ball |
| | link_Puppy | | 300 | 350 | 50 | Play | Roll Right Back to Idle position |
| | link_Puppy | | 15 | 45 | 30 | Loop | Sit Idle Anim |

The script may use select sequences from this list. For example, frames 10-15 (Go to sit position) and 15-45 (Sit idle anim) may not be featured in the puppy animation sequences that have been used. One possible exercise would be to change the puppy navkey listeners from (e.g.)

<q3danim when=“_key[(@_key == _keyleft) and ({/var/object} ==
‘puppy’)]” node=“link_puppy” sframe=“250” eframe=“350”
res=“3D/PuppyModel_qxa” loop=“_once”/>
to a <seq> like:
<seq when=“_key[(@_key == _keyleft) and ({/var/object} ==
‘puppy’)]” >
<q3danim node=“link_puppy” sframe=“250” eframe=“350”
res=“3D/PuppyModel_qxa” loop=“_once”/>
<q3danim node=“link_puppy” sframe=“15” eframe“=45”
res=“3D/PuppyModel_qxa” loop=“_normal”/>
</seq>

The <seq> tag works by processing each child in turn, but doesn't fire a child until the previous one has completed. Thus, frames 250-350 are run once, and then frames 15-45 are looped once the first sequence has finished and until some other animation event has fired.

Camera Motion.

The next group of four listeners does very much the same thing for the camera, this time testing that the device is in “camera” mode (the camera has two sub-modes of smooth and stepped, so the listeners test that the device is in smooth mode in this instance). If so, animations are applied from the resource PuppyScene_qxa to the node Puppycam. Note how this differs from the puppy animations: a different set of animations is taken from a different file, and applied to a different node. Because there is a different animation file, the frame numbers are different—this time the effect of the animation is to take the node to which the camera is attached and spin it around in a circle about the puppy. Here is an example list of frames available for the camera:

Camera Motion Sequence

| | | Node | | | | | |
|---|---|---|---|---|---|---|---|
| Sequence Name | File Name | Name | Start Frame | End Frame | Frame Number | Loop/Hold | Description |
| Turning right | Scene-Puppy | Puppycam | 0 | 15 | 15 | Play | Rotate camera to right 45 degree |
| | Scene-Puppy | Puppycam | 15 | 30 | 15 | Play | Rotate camera to right 45 to 90 |
| | Scene-Puppy | Puppycam | 30 | 45 | 15 | Play | Rotate camera to right 90 to136 |
| | Scene-Puppy | Puppycam | 45 | 60 | 15 | Play | Rotate camera to right 135 to 180 |
| | Scene-Puppy | Puppycam | 60 | 75 | 15 | Play | Rotate camera to right 180 to 225 |
| | Scene-Puppy | Puppycam | 75 | 90 | 15 | Play | Rotate camera to right 225 to 270 |
| | Scene-Puppy | Puppycam | 90 | 105 | 15 | Play | Rotate camera to right 270 to 315 |
| | Scene-Puppy | Puppycam | 105 | 120 | 15 | Play | Rotate camera to right 315 to 360 |
| Turning right | Scene-Puppy | Puppycam | 120 | 135 | 15 | Play | Rotate camera to left 45 degree |
| | Scene-Puppy | Puppycam | 135 | 150 | 15 | Play | Rotate camera to left 45 to 90 |
| | Scene-Puppy | Puppycam | 150 | 165 | 15 | Play | Rotate camera to left 90 to136 |
| | Scene-Puppy | Puppycam | 165 | 180 | 15 | Play | Rotate camera to left 135 to 180 |
| | Scene-Puppy | Puppycam | 180 | 195 | 15 | Play | Rotate camera to left 180 to 225 |
| | Scene-Puppy | Puppycam | 195 | 210 | 15 | Play | Rotate camera to left 225 to 270 |
| | Scene-Puppy | Puppycam | 210 | 225 | 15 | Play | Rotate camera to left 270 to 315 |
| | Scene-Puppy | Puppycam | 225 | 240 | 15 | Play | Rotate camera to left 315 to 360 |
| Rotate Up | Scene-Puppy | Puppycam | 240 | 255 | 15 | Play | Rotate camera up 45 degrees |
| | Scene-Puppy | Puppycam | 255 | 270 | 15 | Play | Rotate camera up 90 degree |
| Rotate Down | Scene-Puppy | Puppycam | 300 | 315 | 15 | Play | Rotate camera Down 45 degree |
| | Scene-Puppy | Puppycam | 315 | 330 | 15 | Play | Rotate camera Down 90 degree |
| Zoom In | Scene-Puppy | Puppycam | 360 | 390 | 15 | Play | Zoom in |
| | Scene-Puppy | Puppycam | 390 | 360 | 30 | Play | Zoom back out |
| Zoom Out | Scene-Puppy | Puppycam | 391 | 416 | 30 | Play | Zoom out |
| | Scene-Puppy | Puppycam | 416 | 391 | 25 | Play | Zoom back in |

The processing performed by each of the elements shown in the figures may be performed by a general purpose computer alone or in connection with a specialized processing computer. Such processing may be performed by a single platform or by a distributed processing platform. In addition, such processing can be implemented in the form of special purpose hardware or in the form of software being run by a general purpose computer. Any data handled in such processing or created as a result of such processing can be stored in any type of memory. Such data may be stored in a temporary memory, such as in the RAM of a given computer system or subsystem. In addition, or in the alternative, such data may be stored in longer-term storage devices, for example, magnetic discs, rewritable optical discs, and so on. For purposes of the disclosure herein, computer-readable media may comprise any form of data storage mechanism, including such different memory technologies as well as hardware or circuit representations of such structures and of such data.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees, and others.

What is claimed

1. Apparatus comprising:
exported assets defining a 3D user interface, the exported assets including 3D model assets defining 3D models and animation assets defining animations of the 3D models, the exported assets being exported from a 3D image defining system; and
an exporter to export the exported assets from a 3D image defining system, to cause the exported assets to be in a format usable in a graphics engine in an embedded device.

2. The apparatus according to claim 1, further comprising a standard 3D modeling system to create the 3D model assets and the animation assets.

3. The apparatus according to claim 1, wherein the exported assets further define textures associated with shapes in the 3D models.

4. The apparatus according to claim 2, wherein the graphics engine comprises an Open GL-ES-compatible, Direct 3D mobile-compatible, and SKT GIGA-compatible graphics engine.

5. The apparatus according to claim 1, wherein the embedded device comprises a mobile embedded device.

6. The apparatus according to claim 1, wherein the 3D image defining system comprises a standard 3D modeling or image processing system.

7. The apparatus according to claim 1, wherein the embedded device comprises a handheld mobile communications device platform.

8. The apparatus according to claim 1, further comprises a tool chain including the exporter.

9. The apparatus according to claim 1, wherein the 3D model assets define 3D icons and scenes.

10. The apparatus according to claim 9, wherein the tool chain includes a scripting language interface to receive, via a computer screen input, script statements defining a 3D user interface, and to generate a set of script files representing the script statements defining the 3D user interface.

11. The apparatus according to claim 10, wherein the set of script files is stored.

12. The apparatus according to claim 10, wherein the script files include XML script.

13. The apparatus according to claim 10, wherein the tool chain further includes icon association mechanisms to associate a given 3D object in a scene with a mobile phone interface tool to cause, by manipulation of the given 3D object, at least one of an input and an output of a signal or information regarding the mobile phone.

14. The apparatus according to claim 13, wherein the input involves a controlling function, a switch state change, and text input.

15. The apparatus according to claim 13, wherein the output involves information display, or a status indication.

16. The apparatus according to claim 14, wherein the output involves an information display, or a status indication.

17. The apparatus according to claim 16, wherein the input and the output are each regarding operations, settings, events, and statuses of a mobile phone.

18. The apparatus according to claim 10, wherein the exporter includes a file generator to generate 3D model files, animation files, and texture files.

19. The apparatus according to claim 17, wherein the exporter includes a file generator to generate 3D model files, animation files, and texture files.

20. The apparatus according to claim 18, wherein the file generator also generates user interface layout files.

21. The apparatus according to claim 19, wherein the file generator also generates user interface layout files.

22. Apparatus comprising:
exported assets defining a 3D user interface, the exported assets including 3D model assets defining 3D models and animation assets defining animations of the 3D models, the exported assets being in a format usable in a graphics engine in an embedded device; and
a graphics engine in an embedded device, the graphics engine including API calls that directly call API functions of a hardware level API.

23. An apparatus according to claim 22, wherein the hardware level API includes Open GL-ES, Direct 3D mobile, and SKT GIGA.

24. The apparatus according to claim 22, wherein the embedded device comprises a mobile device.

25. A method comprising:
providing exported assets defining a 3D user interface, the exported assets including 3D model assets defining 3D models and animation assets defining animations of the 3D models, the exported assets being exported from a 3D image defining system; and
exporting the exported assets from a 3D image defining system, to cause the exported assets to be in a format usable in a graphics engine in an embedded device.

26. The method according to claim 25, wherein the image defining system includes a standard 3D modeling system to create the 3D model assets and the animation assets.

27. The method according to claim 25, wherein the exported assets further define textures associated with shapes in the 3D models.

28. The method according to claim 26, wherein the graphics engine includes an Open GL-ES-compatible, Direct 3D-compatible, and SKT GIGA-compatible graphics engine.

29. The method according to claim 25, wherein the embedded device includes a mobile embedded device.

30. The method according to claim 25, wherein the 3D image defining system includes a standard 3D modeling or image processing system.

31. The method according to claim 25, further comprising providing a tool chain including an exporter to export the exported assets.

32. The method according to claim 25, wherein the 3D model assets define 3D icons and scenes.

33. The method according to claim 32, further comprising providing the tool chain including providing a scripting interface to receive, via a computer screen input, script statements defining a 3D user interface, and to generate a set of script files representing the script statements defining the 3D user interface.

34. The method according to claim 33, further comprising an icon association mechanism associating a given 3D object in a scene with a mobile phone interface tool, to cause, by manipulation of the 3D object via a screen of an embedded device, at least one of an input and an output of a signal or information regarding the mobile phone.

35. An integrated circuit comprising:
exported assets stored on the integrated circuit, the exported assets defining a 3D user interface and including 3D model assets defining 3D models and animation assets defining animations of the 3D models, the exported assets being exported from a 3D image defining system; and
a graphics engine in an embedded device, the graphics engine including API calls that directly call API functions of a hardware level API.

36. The integrated circuit according to claim 35, wherein the hardware level API includes Open GL-ES, Direct 3D mobile, and SKT GIGA software.

37. Apparatus comprising:
means for defining exported assets defining a 3D user interface, the exported assets including 3D model assets defining 3D models and animation assets defining animations of the 3D models, the exported assets being exported from a 3D image defining system; and
means for exporting the exported assets from a 3D image defining system, to cause the assets to be in a form usable in a graphics engine in an embedded device.

38. The apparatus according to claim 37, further comprising means for performing standard 3D modeling to create the 3D model assets and the animation assets.

39. The apparatus according to claim 37, further comprising means for defining textures associated with shapes in the 3D models.

40. The apparatus according to claim 38, wherein the graphics engine includes means for interfacing the graphics engine with an Open GL-ES, Direct 3D mobile, and SKT GIGA API.

41. The apparatus according to claim 37, wherein the embedded device is a mobile embedded device.

42. The apparatus according to claim 37, further comprising means for scripting, the means for scripting including means for receiving, via computer screen input, script statements defining a 3D user interface, the means for scripting further comprising means for generating a set of script files representing the script statements defining the 3D user interface.

43. The apparatus according to claim 42, further comprising means for associating a given 3D object in a scene with a mobile phone interface tool to cause, by manipulation of the given 3D object on a screen of an embedded device, at least one of an input and output of a signal or information regarding the mobile phone.

44. Machine-readable media encoded with data, the data interoperable with a machine to cause:
providing exported assets defining a 3D user interface, the exported assets including 3D model assets defining 3D models and animation assets defining animations of the 3D models, the exported assets being exported from a 3D image defining system; and
exporting the exported assets from a 3D image defining system, to cause the exported assets to be in a format usable in a graphics engine in an embedded device.

45. The machine-readable media according to claim 44, the data being encoded and interoperable with a machine to further cause:
providing a standard 3D modeling system to create the 3D model assets and the animation assets.

46. The machine-readable media according to claim 44, the data being encoded and interoperable with a machine to further cause:
the exported assets defining textures associated with shapes in the 3D models.

47. The machine-readable media according to claim 44, the data being encoded and interoperable with a machine to further cause:
the defined 3D model assets to define 3D icons and scenes.

48. The machine-readable media according to claim 47, the data being encoded and interoperable with a machine to further cause:
providing a tool chain including a scripting language interface to receive, via a computer screen input, script statements defining a 3D user interface, and to generate a set of script files representing the script statements defining the 3D user interface.

49. The machine-readable media according to claim 47, the data being encoded and interoperable with a machine to further cause:
an icon associating mechanism associating a given 3D object in a scene with a mobile phone interface tool to cause, by manipulation of the given 3D object on a screen of a mobile phone, at least one of an input and an output of a signal or information regarding the mobile phone.
